(19) United States
(12) Patent Application Publication
(10) Pub. No.: US 2026/0320761 A1
(43) Pub. Date: Oct. 15, 2026

(54) CONTROL METHOD FOR PROJECTION APPARATUS, CONTROL DEVICE FOR PROJECTION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Yutaro IIJIMA, Matsumoto-shi (JP); Shiki FURUI, Matsumoto-shi (JP)

(73) Assignee: SEIKO EPSON CORPORATION, Tokyo (JP)

(21) Appl. No.: 19/644,001

(22) Filed: Apr. 10, 2026

(30) Foreign Application Priority Data
Apr. 11, 2025 (JP) 2025-065815

(51) Int. Cl. G06T 5/80; G06T 11/00; H04N 5/74

(52) U.S. Cl. CPC G06T 5/80; G06T 11/00; H04N 5/74

(57) ABSTRACT

A control method for a projection apparatus includes generating first matrix information indicating a relative attitude between a screen and a projection lens based on an image generated by a light modulator at a first timing, generating second matrix information indicating an amount of change in an attitude of the projection apparatus from the first timing to a second timing, generating third matrix information indicating a relative attitude between the screen and the projection lens at the second timing based on the first matrix information and the second matrix information, and generating current correction value information for correcting a shape of the image at the second timing based on the third matrix information.

The present application is based on, and claims priority from JP Application Serial Number 2025-065815, filed Apr. 11, 2025, the disclosure of which is hereby incorporated by reference herein in its entirety.

### BACKGROUND

### 1. Technical Field

The present disclosure relates to a control method for a projection apparatus, a control device for a projection apparatus, and a non-transitory computer-readable storage medium storing a program.

### 2. Related Art

There is known a projector that automatically corrects keystone distortion generated when the projector is installed. For example, JP-A-2010-109585 discloses a projector that stops keystone distortion correction processing when the start of movement of the projector is detected, and starts keystone distortion correction processing when the stop of movement of the projector is detected.

JP-A-2010-109585 is an example of the related art.

However, in the technique according to JP-A-2010-109585, for the keystone distortion correction processing, after the movement of the projector is stopped, the screen on which a distance detection pattern is projected is imaged, and the distances to a plurality of points on the screen are measured based on the captured image, thereby calculating the tilt of the projector with respect to the screen. Therefore, there is a problem that the processing load of the processing device increases.

### SUMMARY

A control method for a projection apparatus according to an aspect of the present disclosure is a control method for a projection apparatus including an image generation element that generates an image and a projection lens that projects the image generated by the image generation element onto a projection target, and the control method includes generating first information indicating a relative attitude between the projection target and the projection lens at a first timing based on the image generated by the image generation element at the first timing, generating second information indicating an amount of change from an attitude of the projection apparatus at the first timing to an attitude at a second timing at a time after the first timing based on a detection value output from a sensor that detects the amount of change, generating third information indicating a relative attitude between the projection target and the projection lens at the second timing based on the first information and the second information, and generating fourth information for correcting a shape of the image at the second timing based on the third information.

A control device for a projection apparatus according to an aspect of the present disclosure is a control device for a projection apparatus including an image generation element that generates an image and a projection lens that projects the image generated by the image generation element onto a projection target, and the control device includes a first information generator that generates first information indicating a relative attitude between the projection target and the projection lens at a first timing based on the image generated by the image generation element at the first timing, a second information generator that generates second information indicating an amount of change from an attitude of the projection apparatus at the first timing to an attitude at a second timing at a time after the first timing based on a detection value output from a sensor that detects the amount of change, a third information generator that generates third information indicating a relative attitude between the projection target and the projection lens at the second timing based on the first information and the second information, and a fourth information generator that generates fourth information for correcting a shape of the image at the second timing based on the third information.

A non-transitory computer-readable storage medium storing a program according to an aspect of the present disclosure causes a computer that controls a projection apparatus including an image generation element that generates an image and a projection lens that projects the image generated by the image generation element onto a projection target to execute generating first information indicating a relative attitude between the projection target and the projection lens at a first timing based on the image generated by the image generation element at the first timing, generating second information indicating an amount of change from an attitude of the projection apparatus at the first timing to an attitude at a second timing at a time after the first timing based on a detection value output from a sensor that detects the amount of change, generating third information indicating a relative attitude between the projection target and the projection lens at the second timing based on the first information and the second information, and generating fourth information for correcting a shape of the image at the second timing based on the third information.

### BRIEF DESCRIPTION OF THE DRAWINGS

FIG. 1 is a configuration diagram of a projection system according to a first embodiment.

FIG. 2 is a schematic diagram showing a state in which a second projection image is displayed at a second timing.

FIG. 3 is a block diagram showing a configuration of a projector shown in FIG. 1.

FIG. 4 is a block diagram showing a configuration of a storage device for the projector shown in FIG. 1.

FIG. 5 shows panel coordinates on a liquid crystal panel.

FIG. 6 shows coordinate transformation by a pinhole camera model.

FIG. 7 shows a horizontal vanishing point and a vertical vanishing point.

FIG. 8 shows examples of a projector coordinate system and a screen coordinate system.

FIG. 9 is a correlation diagram showing a relationship among a first rotation matrix, a second rotation matrix, and a third rotation matrix.

FIG. 10 shows a rotation vector Vr.

FIG. 11 is a flowchart showing an example of an operation of a processing device shown in FIG. 3.

FIG. 12 is a flowchart showing an example of an operation of a subroutine shown in FIG. 11.

### DESCRIPTION OF EMBODIMENTS

Hereinafter, preferred embodiments according to the present disclosure will be described with reference to the accompanying drawings. In the drawings, the dimensions and scales of the respective parts may be different from the actual ones, and some parts may be schematically shown in order to facilitate understanding. The scope of the present disclosure is not limited to the embodiments unless otherwise specifically stated in the following description.

### 1. First Embodiment

### 1.1. Overview of Image Display System

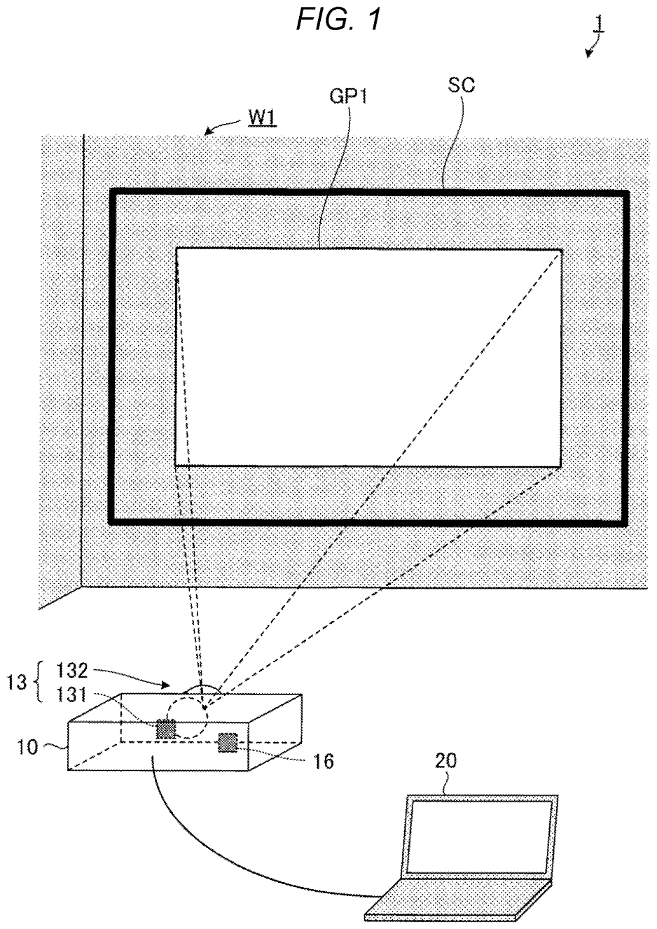

Hereinafter, a projection system 1 according to a first embodiment will be described with reference to FIGS. 1 to 12.

FIG. 1 is a configuration diagram of the projection system 1 according to the first embodiment. The projection system 1 includes a projection apparatus 10, a terminal device 20, and a screen SC. The projection apparatus 10 is coupled to the terminal device 20. The projection apparatus 10 receives image data from the terminal device 20 and projects an image on the screen SC based on the received image data. The screen SC is provided on a wall surface W1 of a room.

The image projected on the screen SC is hereinafter referred to as a projection image. The surface on which the projection image is projected is not limited to the screen SC, and may be the wall surface W1, a ceiling, or the like.

In the present embodiment, the terminal device 20 is a personal computer. The terminal device 20 outputs information of the image projected on the screen SC to the projection apparatus 10.

In the example shown in FIG. 1, since the projection light of the projection apparatus 10 is projected from an oblique angle with respect to the screen SC, a first projection image GP1 is distorted like a trapezoid before a correction is performed. Therefore, in the projection apparatus 10, a keystone distortion correction is performed so that the first projection image GP1 is displayed in a rectangular shape on the screen SC.

### 1.2. Outline of Projection Apparatus

FIG. 1 shows a state in which the first projection image GP1 is displayed at a first timing. As described above, the first projection image GP1 is an image for which the keystone distortion correction is completed. That is, the first timing refers to a time point when the past keystone distortion correction is completed.

The projection apparatus 10 includes a projector 13 that projects a projection light onto a projection surface and an attitude detection device 16 that detects the attitude of the projection apparatus 10. The projector 13 includes a light source (not shown), a light modulator 131 that modulates a light emitted from the light source into a projection light for displaying a projection image on a projection surface, a projection lens 132 that projects the projection light modulated by the light modulator 131 on the projection surface, and a housing (not shown) that houses the respective members including the projection lens 132. The light modulator 131 includes a plurality of pixels. The light modulator 131 is an example of an image generation element. The image generation element may be a digital mirror device. The attitude detection device 16 detects at least a change in the relative attitude, that is, the attitude of the projection apparatus 10 or the projector 13. For example, the attitude detection device 16 includes a gyro sensor capable of detecting an angular velocity of one or more axes, and is fixed to the housing described above that houses at least a part of the projector 13. The attitude detection device 16 is calibrated with respect to the coordinate system of the projector 13, that is, the coordinate system of the projection lens 132. Thus, the output value from the attitude detection device 16 is treated as a value in the coordinate system of the projector 13. The projection apparatus 10 controls the projector 13 to display a projection image on the projection surface. In the present embodiment, the projection apparatus 10 controls the projector 13 to display the first projection image GP1 on the screen SC.

When the attitude of the projection apparatus 10 at the first timing is defined as a first attitude, the first attitude is detected by the attitude detection device 16. First attitude information indicating the detected first attitude is stored in the storage device 11. The keystone distortion correction may be automatically performed using an automatic correction function of the projection apparatus 10, or may be manually performed by a user while referring to a projection image projected on the screen SC so that the projection image becomes rectangular. The first correction information indicating a correction value after the keystone distortion correction is stored in the storage device 11.

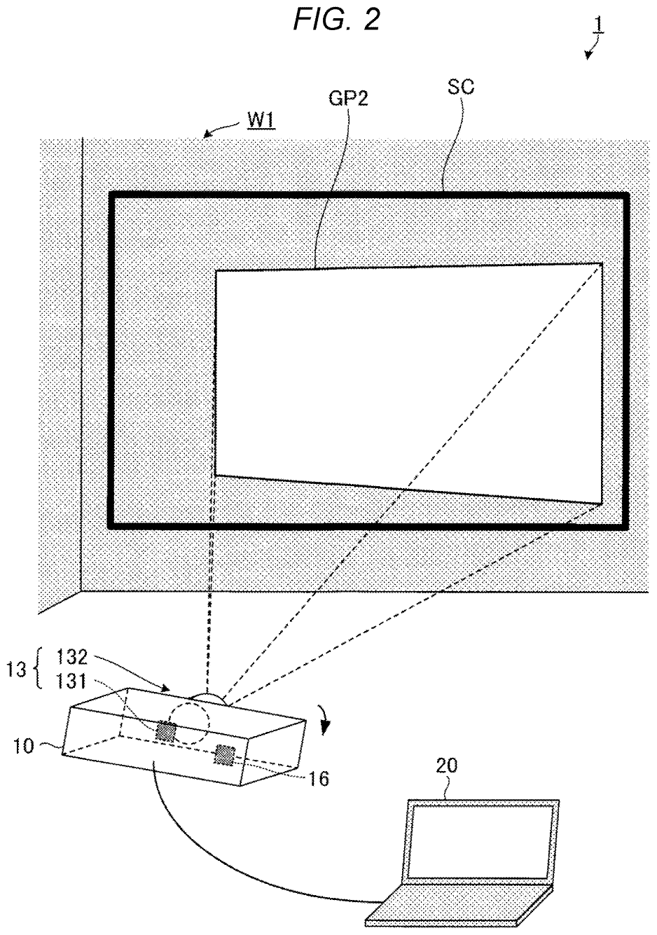

FIG. 2 is a schematic diagram showing a state in which a second projection image GP2 is displayed at a second timing. The projection apparatus 10 (projector 13) projects a projection light on the screen SC to display the second projection image GP2. The second timing is at a time after the first timing, and is a time when the correction value after the keystone distortion correction does not change from the correction value at the first timing.

When the attitude of the projection apparatus 10 (projector 13) at the second timing is defined as a second attitude, the second attitude is detected by the attitude detection device 16. Second attitude information indicating the detected second attitude is stored in the storage device 11.

As shown in FIG. 2, since the second attitude is changed from the first attitude, the shape of the second projection image GP2 is not rectangular. Therefore, thereafter, it is necessary to correct the second projection image GP2 into a rectangle like the first projection image GP1 shown in FIG. 1 by performing the keystone distortion correction. Hereinafter, a method of calculating a correction value of the keystone distortion correction in the second attitude will be described while describing the configuration of the projection apparatus 10.

### 1.3. Configuration of Projection Apparatus

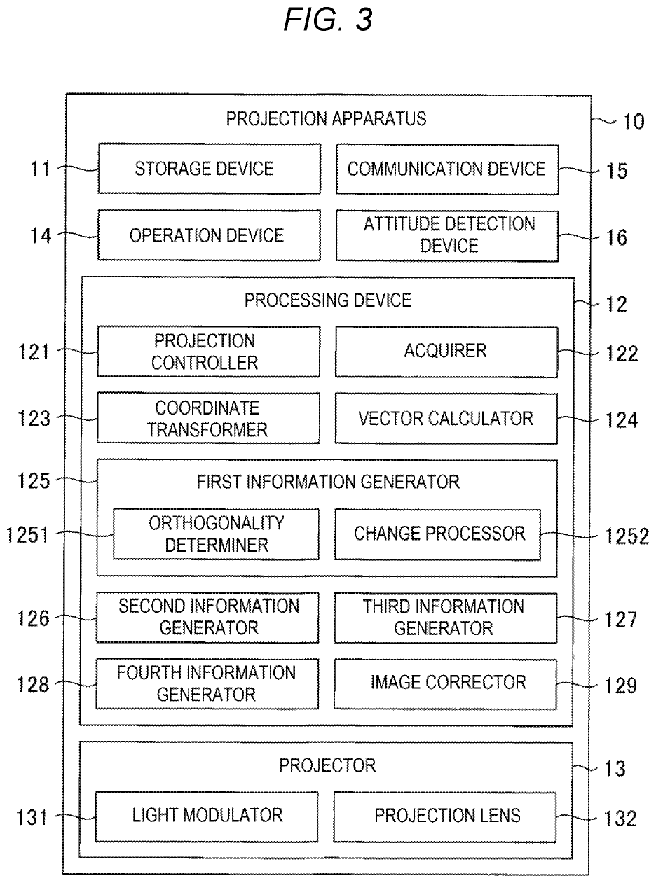

FIG. 3 is a block diagram showing a configuration of the projection apparatus 10 shown in FIG. 1. The projection apparatus 10 includes the storage device 11 that stores various types of information, a processing device 12 that controls the operation of the projection apparatus 10, the projector 13 that projects a projection light onto a projection surface, an operation device 14 that receives an input operation from a user, a communication device 15 that communicates with other devices, and the attitude detection device 16 that detects the attitude of the main body of the projection apparatus 10. The elements provided in the projection apparatus 10 are coupled to one another by a single bus or a plurality of buses for communicating information.

The processing device 12 has functions as a projection controller 121, an acquirer 122, a coordinate transformer 123, a vector calculator 124, a first information generator 125, a second information generator 126, a third information generator 127, a fourth information generator 128, and an image corrector 129. The processing device 12 is an example of a computer that controls the projection apparatus 10. Another example of the computer is a personal computer externally coupled to the projection apparatus 10.

The storage device 11 includes, for example, a volatile memory such as a RAM and a nonvolatile memory such as a ROM. RAM is an abbreviation for random-access memory. ROM is an abbreviation for read-only memory.

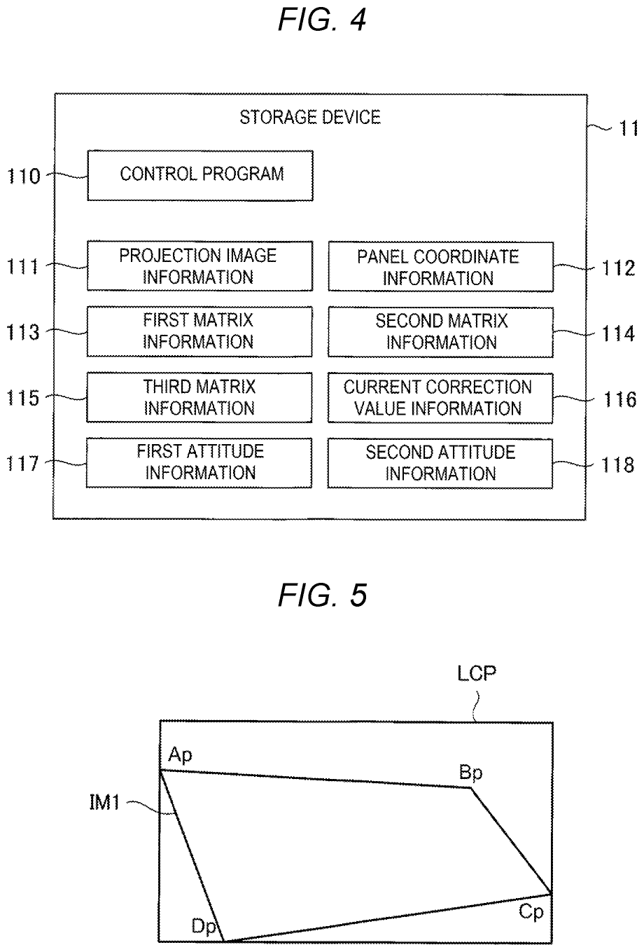

FIG. 4 is a block diagram showing a configuration of the storage device 11 of the projection apparatus 10 shown in FIG. 1. The nonvolatile memory provided in the storage device 11 stores a control program 110 that specifies the operation of the projection apparatus 10, projection image information 111 representing an image projected on the projection surface, panel coordinate information 112, first matrix information 113, second matrix information 114, third matrix information 115, current correction value information 116, first attitude information 117, and second attitude information 118.

The projection image information 111 is information representing an image projected when the first projection image GP1 and the second projection image GP2 are displayed. That is, in the present embodiment, the image used for the first projection image GP1 and the image used for the second projection image GP2 are the same image. The image used for the first projection image GP1 and the image used for the second projection image GP2 may be different from each other. In this case, the projection image information 111 includes first projection image information and second projection image information.

The panel coordinate information 112 is information indicating a correction value when the keystone distortion correction is performed at the first timing. The “panel coordinate information” refers to information expressed by coordinates on the liquid crystal panel forming the light modulator 131. When the second timing is the current correction timing, the first timing is the previous correction timing. Therefore, the “panel coordinate information” corresponds to information indicating the correction value at the time of the previous correction, and is paraphrased as “previous correction value information”.

The first matrix information 113 is information indicating a first rotation matrix generated in the first information generator 125. The second matrix information 114 is information indicating a second rotation matrix generated in the second information generator 126. The third matrix information 115 is information indicating a third rotation matrix generated in the third information generator 127. The first matrix information 113 is an example of first information. The second matrix information 114 is an example of second information. The third matrix information 115 is an example of third information.

The current correction value information 116 is information indicating the correction value generated by the fourth information generator 128 at the second timing. The first attitude information 117 is information indicating the attitude of the projection apparatus 10 at the first timing. The second attitude information 118 is information indicating the attitude of the projection apparatus 10 at the second timing. The current correction value information 116 is an example of fourth information.

The volatile memory provided in the storage device 11 is used by the processing device 12 as a work area for executing the control program 110.

A part or all of the storage device 11 may be provided in an external storage device, an external server, or the like. A part or all of the various types of information stored in the storage device 11 may be stored in the storage device 11 in advance, or may be acquired from an external storage device, an external server, or the like.

Referring again to FIG. 3, the processing device 12 includes one or more CPUs. However, the processing device 12 may include a programmable logic device such as an FPGA or an ASIC, instead of the CPU or in addition to the CPU. CPU is an abbreviation for central processing unit, FPGA is an abbreviation for field-programmable gate array, and ASIC is an abbreviation for application-specific integrated circuit.

In the present embodiment, the projection controller 121 controls the projector 13 to project a projection light for displaying an image on the screen SC as the projection surface.

Specifically, the projection controller 121 causes the projector 13 to project the projection light based on the projection image information 111 to display the projection image on the screen SC.

The projector 13 projects the projection light on the screen SC. As described above, the projector 13 includes the light source (not shown), the light modulator 131, and the projection lens 132. The light source is a white light source. As the light source, a halogen lamp, a xenon lamp, an ultra-high pressure mercury lamp, an LED, a laser light source, or the like is used. The projector 13 projects a projection light for displaying a projection image on the projection surface under the control of the projection controller 121. In other words, the projector 13 projects the image input from the processing device 12 onto the projection surface.

The light modulator 131 includes, for example, one or more liquid crystal panels. The light modulator 131 may include a DMD instead of the liquid crystal panel. The light modulator 131 modulates the light emitted from the light source into a projection light for displaying a projection image on the projection surface based on a signal input from the processing device 12. Here, LED is an abbreviation for light-emitting diode, and DMD is an abbreviation for digital mirror device.

The projection lens 132 images the projection light modulated by the light modulator 131 on the projection surface.

The operation device 14 receives an input operation on the projection apparatus 10 from the user of the projection apparatus 10. The operation device 14 includes, for example, a touch panel or an operation button provided in the housing of the projection apparatus 10. When the operation device 14 includes the touch panel, the operation device 14 outputs data representing a detected touch position to the processing device 12. When the operation device 14 includes the operation button, the operation device 14 outputs data for identifying a pressed button to the processing device 12. The operation device 14 may include a receiving device for receiving an operation signal output from a remote controller based on an operation by the user. When the operation device 14 includes the receiving device, the operation device 14 outputs data represented by the operation signal received from the remote controller to the processing device 12. Thus, the details of the input operation to the projection apparatus 10 are transmitted to the processing device 12.

The communication device 15 is hardware serving as a transmitting and receiving device for communication with other devices. The communication device 15 is also called, for example, a network device, a network controller, a network card, or a communication module. The communication device 15 may include a connector for wired connection and an interface circuit corresponding to the connector. The communication device 15 may include a wireless communication interface. Examples of the connector for wired connection and the interface circuit include products conforming to HDMI (high-definition multimedia interface (registered trademark)), DisplayPort (registered trademark), wired LAN, IEEE1394, USB, or the like. Examples of the wireless communication interface include products conforming to wireless LAN, Bluetooth (registered trademark), or the like.

The attitude detection device 16 detects a relative amount of change in the attitude of the projection apparatus 10 (projector 13) and outputs the detected amount of change in the attitude as a detection value. Specifically, the attitude detection device 16 is a gyro sensor, a rotary encoder, or the like. The attitude detection device 16 can detect roll, pitch, and yaw. Since the projector 13 is fixed to the housing of the projection apparatus 10, the detected amount of change in the attitude is equivalent to the amount of change in the attitude of the projector 13. In the present embodiment, the attitude detection device 16 particularly detects the amount of change of the projection apparatus 10 from the first attitude at the first timing to the second attitude at the second timing.

The processing device 12 reads a control program 110 from the storage device 11. By executing the read control program 110, the processing device 12 functions as the projection controller 121, the acquirer 122, the coordinate transformer 123, the vector calculator 124, the first information generator 125, the second information generator 126, the third information generator 127, the fourth information generator 128, and the image corrector 129 shown in FIG. 3.

The projection controller 121 controls the projector 13 to project a projection light for displaying an image on the projection surface. Specifically, the projection controller 121 causes the projector 13 to project the projection light based on the projection image information 111 and display the projection image on the projection surface. In other words, the projection controller 121 causes the projector 13 to project the image represented by the projection image information 111 and display the projection image on the projection surface. The projection controller 121 controls the projector 13 to display an image for assisting the user's operation on the projection surface.

FIG. 5 shows panel coordinates on a liquid crystal panel LCP. When the keystone distortion correction is performed on the first projection image GP1, a generated image IM1 generated on the liquid crystal panel LCP has a distorted quadrangular shape as shown in FIG. 5. In the liquid crystal panel LCP, a plurality of pixels are two-dimensionally arranged. Each of the plurality of pixels indicates coordinates in the liquid crystal panel LCP, that is, panel coordinates. The correction value of the first projection image GP1 can be acquired as panel coordinates. Panel coordinates Ap, Bp, Cp, and Dp are coordinates of points on four corners of the generated image IM1 after correction on the liquid crystal panel LCP. The panel coordinates Ap, Bp, Cp, and Dp are expressed by the following expressions (1) to (4), respectively.

Aₚ=(x_{A},y_{A}) (1)

Bₚ=(x_{B},y_{B}) (2)

Cₚ=(x_{C},y_{C}) (3)

Dₚ=(x_{D},y_{D}) (4)

Referring again to FIG. 3, the acquirer 122 acquires the panel coordinate information 112 indicating the panel coordinates Ap, Bp, Cp, and Dp from the storage device 11.

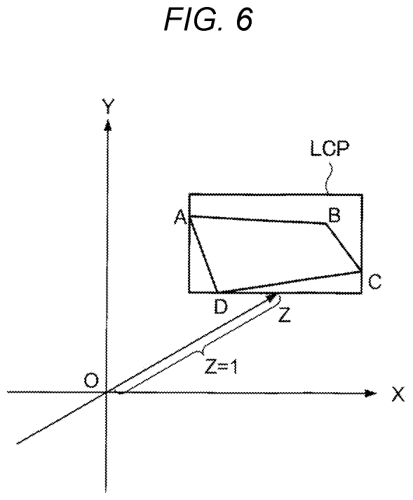

FIG. 6 shows coordinate transformation by a pinhole camera model. By projecting the panel coordinates Ap, Bp, Cp, and Dp on a Z1 plane of three-dimensional coordinates using the pinhole camera model, the panel coordinates Ap, Bp, Cp, and Dp are transformed into four coordinates A, B, C, and D on the Z1 plane. Here, the origin O corresponds to the position of the principal point of the projection lens 132. A Z axis is parallel to the optical axis of the projection system of the projection apparatus 10. An X axis is parallel to the horizontal direction of the liquid crystal panel LCP, and a Y axis is parallel to the vertical direction of the liquid crystal panel LCP. The Z1 plane is a plane parallel to the XY plane at a distance of “1” from the origin O, Z=1. That is, the coordinate system illustrated in FIG. 6 is a normalized coordinate system. The coordinate system shown in FIG. 6 is an example of a coordinate system having the principal point of the projection lens as the origin.

The respective components of the four coordinates A, B, C, and D on the Z1 plane are represented by (X, Y, 1), and components in the X direction and components in the Y direction (X, Y) are extracted from the components. The four coordinates A, B, C, and D on the Z1 plane from which the components (X, Y) are extracted are hereinafter referred to as transformed coordinates A, B, C, and D. The transformed coordinates A, B, C, and D are expressed by expressions (5) to (8), respectively.

A=(X_{A},Y_{A}) (5)

B=(X_{B},Y_{B}) (6)

C=(X_{C},Y_{C}) (7)

D=(X_{D},Y_{D}) (8)

Referring again to FIG. 3, the coordinate transformer 123 transforms the panel coordinates Ap, Bp, Cp, and Dp into the four coordinates A, B, C, and D on the Z1 plane by projection onto the Z1 plane. The coordinate transformer 123 acquires the transformed coordinates A, B, C, and D by extracting the components in the X direction and the components in the Y direction (X, Y) for the four transformed coordinates A, B, C, and D, respectively.

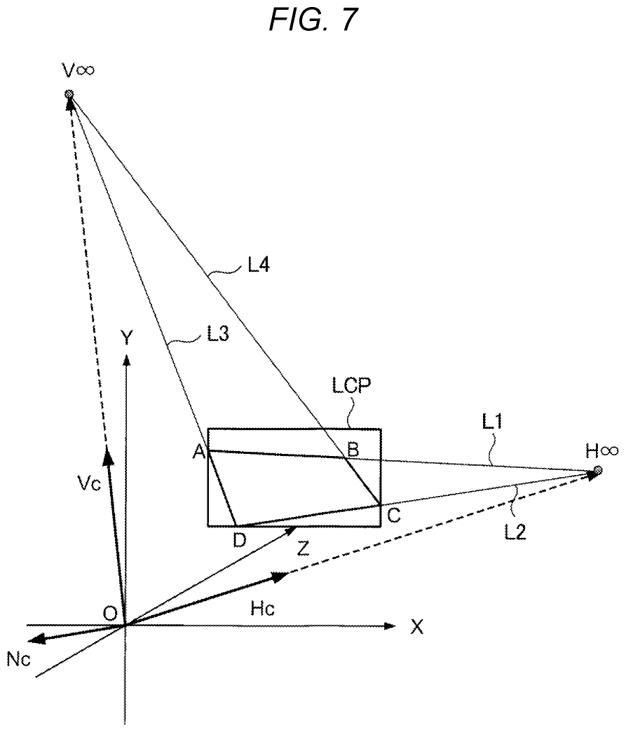

FIG. 7 shows a horizontal vanishing point H∞ and a vertical vanishing point V∞. The horizontal vanishing point H∞ is a point when the point at infinity in the horizontal direction of the screen SC is viewed from the projection apparatus 10 (projection lens 132). The vertical vanishing point V∞ is a point when the point at infinity in the vertical direction of the screen SC is viewed from the projection apparatus 10 (projection lens 132). When projected on the screen SC, the quadrangle ABCD, which is the corrected image, is a rectangle as shown in FIG. 1. The upper side and the lower side of the rectangular corrected image on the screen SC pass through the horizontal vanishing point H∞. The right side and the left side of the rectangular corrected image on the screen SC pass through the vertical vanishing point V∞.

As shown in FIG. 7, a point where an extension line L1 of the side AB and an extension line L2 of the side CD intersect corresponds to the horizontal vanishing point H∞. A point where an extension line L3 of the side AD and an extension line L4 of the side BC intersect corresponds to the vertical vanishing point V∞. Therefore, the horizontal vanishing point H∞ and the vertical vanishing point V∞ are obtained based on the transformed coordinates A, B, C, and D. Since the horizontal vanishing point H∞ and the vertical vanishing point V∞ are the points on the Z1 plane, the horizontal vanishing point H∞ and the vertical vanishing point V∞ are expressed in three-dimensional coordinates by the following expressions (9) and (10).

H∞=(X_{H∞},Y_{H∞},1) (9)

V∞=(V_{V∞},V_{V∞},1) (10)

A vector from the origin O toward the horizontal vanishing point H∞ corresponds to a vector representing the horizontal axis on the projection surface of the screen SC. A vector from the origin O toward the vertical vanishing point V∞ corresponds to a vector representing the vertical axis on the projection surface of the screen SC. For subsequent processing, the vector from the origin O toward the horizontal vanishing point H∞ and the vector from the origin O toward the vertical vanishing point V∞ are normalized. A horizontal vector Hc and a vertical vector Vc respectively normalized are expressed by the following expressions (11) and (12). The horizontal vector Hc is an example of a first vector, and the vertical vector Vc is an example of a second vector.

$${H}_{c} = ( \frac{{X}_{{H}_{∞}}}{‖ {H}_{∞} ‖} , \frac{{Y}_{{H}_{∞}}}{‖ {H}_{∞} ‖} , \frac{1}{‖ {H}_{∞} ‖} ) \qquad ( 11 )$$

$${V}_{c} = ( \frac{{X}_{{H}_{∞}}}{‖ {V}_{∞} ‖} , \frac{{Y}_{{V}_{∞}}}{‖ {V}_{∞} ‖} , \frac{1}{‖ {V}_{∞} ‖} ) \qquad ( 12 )$$

Referring again to FIG. 3, the vector calculator 124 obtains the horizontal vanishing point H∞ and the vertical vanishing point V∞ based on the transformed coordinates A, B, C, and D. The vector calculator 124 normalizes the vector from the origin O toward the horizontal vanishing point H∞ and the vector from the origin O toward the vertical vanishing point V∞, and stores normalized vector information indicating the normalized horizontal vector Hc and vertical vector Vc in the storage device 11.

Referring again to FIG. 7, since the horizontal vanishing point H∞ indicates the horizontal direction of the screen SC and the vertical vanishing point V∞ indicates the vertical direction of the screen SC, a vector orthogonal to each of the horizontal vector Hc and the vertical vector Vc is a normal vector Nc of the screen SC. The normal vector Nc of the screen SC is obtained by calculating an outer product of the horizontal vector Hc and the vertical vector Vc. That is, the normal vector Nc of the screen SC is expressed by the following expression (13). The normal vector Nc is an example of a third vector.

N_{c}=H_{c}×V_{c} (13)

Referring to FIG. 3 again, the vector calculator 124 obtains the normal vector Nc of the screen SC by calculating the outer product of the horizontal vector Hc and the vertical vector Vc.

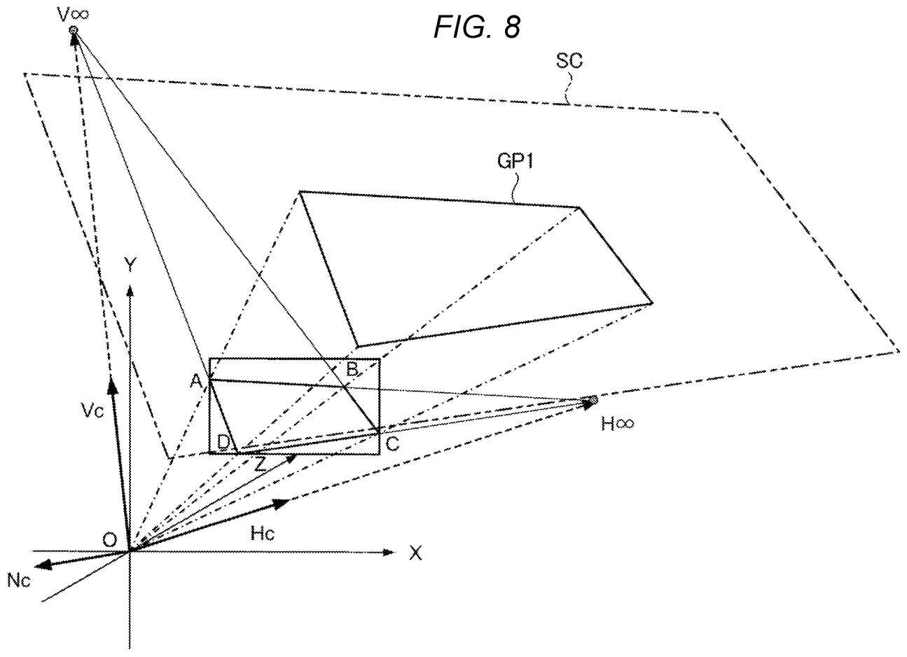

FIG. 8 shows examples of a projector coordinate system and a screen coordinate system. The projector coordinate system is a three-dimensional coordinate system having a principal point of the projection lens 132 as the origin and including an X axis, a Y axis, and a Z axis orthogonal to one another. The screen coordinate system is a three-dimensional coordinate system including an axis in the horizontal side direction of the screen SC, an axis in the vertical side direction, and an axis orthogonal to these axes. The axis in the horizontal side direction is an axis along the horizontal vector Hc. The axis in the vertical side direction is an axis along the vertical vector Vc. The axis orthogonal to the axis in the horizontal side direction and the axis in the vertical side direction is an axis along the normal vector Nc. In the present embodiment, the horizontal vector Hc is a unit vector in the horizontal direction of the screen SC, as shown in FIG. 8 in which the screen coordinate system can be expressed by the above expressions (11) to (13). The vertical vector Vc is a unit vector in the vertical direction of the screen SC. The normal vector Nc is a unit vector perpendicular to the projection surface of the screen SC. Accordingly, the horizontal vector Hc, the vertical vector Vc, and the normal vector Nc are orthonormal bases of the screen SC. Therefore, a matrix in which these three vectors are transposed and horizontally arranged indicates a rotation matrix between the projector coordinate system and the screen coordinate system, that is, the relative attitude between the screen SC and the projection lens 132. Hereinafter, this rotation matrix is referred to as a first rotation matrix Rp. The first rotation matrix Rp is expressed by the following expression (14).

$${R}_{p} = ( {H}_{C}^{T} {V}_{C}^{T} {N}_{C}^{T} ) = ( \begin{matrix}{X}_{{H}_{c}} & {X}_{{V}_{c}} & {X}_{{N}_{c}} \\ {Y}_{{H}_{c}} & {Y}_{{H}_{c}} & {Y}_{{N}_{c}} \\ {Z}_{{H}_{c}} & {Z}_{{V}_{c}} & {Z}_{{N}_{c}}\end{matrix} ) \qquad ( 14 )$$

Referring again to FIG. 3, the first information generator 125 obtains the first rotation matrix Rp based on the horizontal vector Hc, the vertical vector Vc, and the normal vector Nc. The first information generator 125 generates first matrix information 113 indicating the obtained first rotation matrix Rp, and stores the generated first matrix information 113 in the storage device 11. The first matrix information 113 is an example of first information.

Note that when the projection image to which the set image correction value is applied does not form a perfect rectangle on the screen SC, the horizontal vector Hc and the vertical vector Vc may not be orthogonal to each other. In this case, it is desirable to adjust at least one of the horizontal vector Hc and the vertical vector Vc so that the horizontal vector Hc and the vertical vector Vc are orthogonal to each other. Here, to adjust is to change a vector component.

A projection image projected by the projection apparatus 10 (projector 13) generally has a horizontally long aspect ratio as in the present embodiment. In a horizontally long quadrangle that is not a perfect rectangle, it is easier to visually recognize that the upper side and the lower side are not parallel to each other than that the left side and the right side are not parallel to each other. This is because, in the horizontally long quadrangle, the lengths of the upper side and the lower side are longer than the lengths of the left side and the right side.

In this viewpoint, when the person in charge of installing the projection apparatus 10 determines the image correction value so that the projection image projected on the screen SC has a rectangular shape, the degree of parallelism between the upper side and the lower side of the projection image for which the image correction value is determined is higher than the degree of parallelism between the left side and the right side of the projection image. In other words, the upper side and the lower side of the projection image for which the image correction value is determined are less deviated from those of an ideal rectangle than the left side and the right side of the projection image. Therefore, when the projection image is not completely rectangular on the screen SC, it is conceivable to adjust the vertical vector Vc without adjusting the horizontal vector Hc.

In the present embodiment, the first information generator 125 has functions of an orthogonality determiner 1251 and a change processor 1252. The orthogonality determiner 1251 determines whether the horizontal vector Hc and the vertical vector Vc are orthogonal to each other. Specifically, the orthogonality determiner 1251 obtains an inner product of the horizontal vector Hc and the vertical vector Vc. Since the horizontal vector Hc and the vertical vector Vc are unit vectors, when an angle formed by the horizontal vector Hc and the vertical vector Vc is φ, the inner product of the horizontal vector Hc and the vertical vector Vc is expressed by cos φ. In the present embodiment, when the absolute value |cos φ| of the inner product cos φ is less than a threshold value, it is defined that the horizontal vector Hc and the vertical vector Vc are orthogonal to each other. The threshold is preferably set to a value larger than 0 and sufficiently smaller than 1.

When it is determined that the horizontal vector Hc and the vertical vector Vc are orthogonal to each other, that is, when the absolute value |cos φ| is less than the threshold, it is not necessary to adjust at least one of the horizontal vector Hc and the vertical vector Vc.

When it is determined that the horizontal vector Hc and the vertical vector Vc are not orthogonal to each other, that is, when the absolute value |cos φ| is equal to or larger than the threshold value, the change processor 1252 adjusts the vertical vector Vc. In other words, when it is determined that the horizontal vector Hc and the vertical vector Vc are not orthogonal to each other, the change processor 1252 changes the component of the vertical vector Vc so that the horizontal vector He and the vertical vector Vc are orthogonal to each other. For orthogonalization of the horizontal vector Hc and the vertical vector Vc, for example, Gram-Schmidt orthogonalization is used. Since the Gram-Schmidt orthogonalization is known, the detailed description thereof will be omitted.

After the change processing is performed on the component of the vertical vector Vc, the first information generator 125 obtains the first rotation matrix Rp based on the result of the change processing. That is, the first information generator 125 obtains the first rotation matrix Rp based on the horizontal vector Hc, the changed vertical vector Vc, and the normal vector Nc. The first information generator 125 generates the first matrix information 113 indicating the first rotation matrix Rp obtained again, and stores the generated first matrix information 113 in the storage device 11.

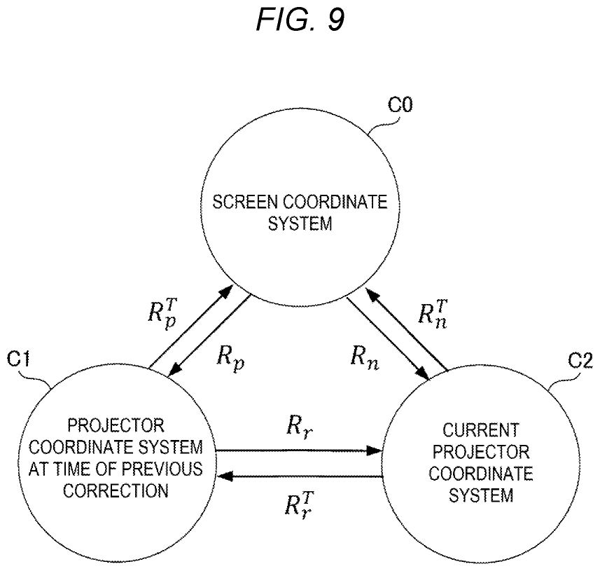

FIG. 9 is a correlation diagram showing a relationship among the first rotation matrix Rp, a second rotation matrix Rr, and a third rotation matrix Rn. As shown in FIG. 9, the first rotation matrix Rp expressing a rotation matrix at the time of the previous correction is a transformation matrix from a screen coordinate system C0 to a projector coordinate system C1 at the time of the previous correction. In contrast, the second rotation matrix Rr expressing a relative rotation matrix acquired from the attitude detection device 16 is a rotation matrix from the projector coordinate system C1 at the time of the previous correction to a current projector coordinate system C2. Therefore, the third rotation matrix Rn expressing a rotation matrix from the screen coordinate system C0 to the current projector coordinate system C2 is expressed by the following expression (15).

Rₙ=RᵣRₚ (15)

In FIG. 9, Rp^{T} indicates a rotation matrix of reverse rotation to the first rotation matrix Rp. Rr^{T} indicates a rotation matrix of reverse rotation to the second rotation matrix Rr. Rn^{T} indicates a rotation matrix of reverse rotation to the third rotation matrix Rn.

The second rotation matrix Rr acquired from the attitude detection device 16 is calculated in the following manner. A value corresponding to the angular velocity in each of the three axes is output from the attitude detection device 16. An angular velocity vector W corresponding to the output of the attitude detection device 16 is defined by the following expression (16).

W=(wₓ,w_{y},w_{z}) (16)

Since the rotation amount is obtained by integrating the angular velocity with time t, the rotation vector Vr corresponding to the output of the attitude detection device 16 is expressed by the following expression (17).

Vᵣ=(vᵣ_{ₓ},vᵣ_{_{y}},vᵣ_{_{z}})=(wₓt,w_{y}t,w_{z}t) (17)

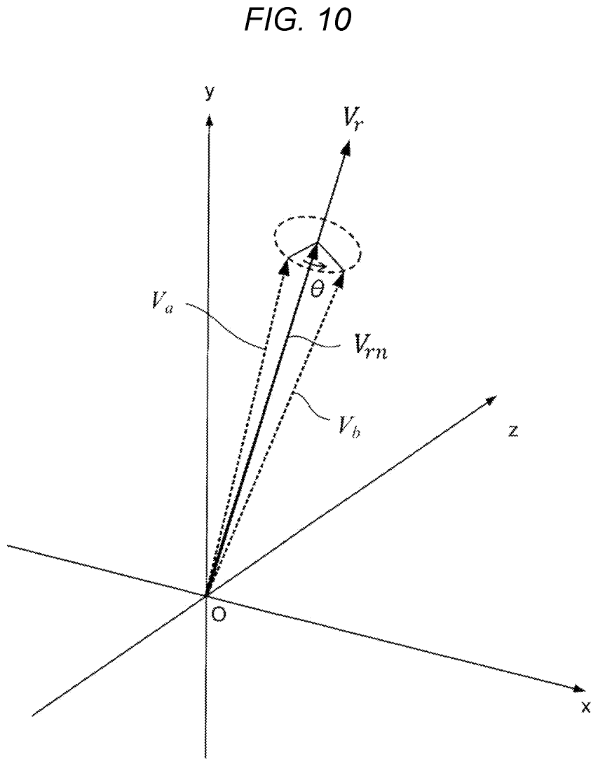

FIG. 10 shows the rotation vector Vr. As shown in FIG. 10, the rotation vector Vr is a vector that expresses rotation by a rotation amount θ expressed by the following expression (19) with a unit vector Vrn expressed by the following expression (18) as a rotation axis. In FIG. 10, a vector Va indicates a vector before rotation, and a vector Vb indicates a vector after rotation.

$${V}_{rn} = ( {v}_{{rn}_{x}} , {v}_{{rn}_{y}} , {v}_{{rn}_{z}} ) = ( \frac{{v}_{{r}_{x}}}{‖ {V}_{r} ‖} , \frac{{v}_{{r}_{y}}}{‖ {V}_{r} ‖} , \frac{{U}_{{r}_{z}}}{‖ {V}_{r} ‖} ) \qquad ( 18 )$$

$$θ = ‖ {V}_{r} ‖ = \sqrt{{v}_{{r}_{x}}^{2} + {v}_{{r}_{y}}^{2} + {v}_{{r}_{z}}^{2}} \qquad ( 19 )$$

The obtained rotation vector Vr can be transformed into a rotation matrix by using the Rodrigues' rotation formula using a coordinate transformation matrix as a matrix of reverse rotation, that is, −θ rotation, and is transformed into the second rotation matrix Rr as expressed by the following expressions (20), (21), and (22).

$${R}_{r} = I + sin ( - θ ) K + ( 1 - cos ( - θ ) ) {K}^{2} \qquad ( 20 )$$

$$I = ( \begin{matrix}1 & 0 & 0 \\ 0 & 1 & 0 \\ 0 & 0 & 1\end{matrix} ) \qquad ( 21 )$$

$$K = ( \begin{matrix}0 & - {v}_{{rn}_{z}} & {v}_{{rn}_{y}} \\ {v}_{{rn}_{z}} & 0 & - {v}_{{rn}_{x}} \\ - {v}_{{rn}_{y}} & {v}_{{rn}_{x}} & 0\end{matrix} ) \qquad ( 22 )$$

In the present disclosure, a relative rotation amount is detected by a gyro sensor or the like, and the measurement value of a sensor such as a gyro sensor is transformed from a local coordinate system of the sensor to the projector coordinate system. Therefore, the sensor is assumed to be calibrated in advance in the manufacturing process or the inspection process so that the transformation from the local coordinate system of the sensor to the projector coordinate system can be performed.

Referring again to FIG. 3, the second information generator 126 obtains the relative second rotation matrix Rr indicating the amount of change from the first attitude to the second attitude based on the detection value output from the attitude detection device 16. The second information generator 126 generates second matrix information 114 indicating the obtained second rotation matrix Rr, and stores the generated second matrix information 114 in the storage device 11. The second matrix information 114 is an example of second information.

The third information generator 127 obtains the third rotation matrix Rn indicating the relative attitude between the screen SC and the projection lens 132 at the second timing based on the first rotation matrix Rp and the second rotation matrix Rr. The third information generator 127 generates third matrix information 115 indicating the obtained third rotation matrix Rn, and stores the generated third matrix information 115 in the storage device 11. The third matrix information 115 is an example of third information.

After the third rotation matrix Rn from the screen coordinate system to the current projector coordinate system is obtained, the correction shape of the projection image is calculated using a general keystone distortion correction method. For example, the keystone distortion correction method uses projective transformation.

The fourth information generator 128 obtains an image correction value for correcting the shape of the projection image at the second timing based on the third matrix information 115. The fourth information generator 128 generates the current correction value information 116 indicating the obtained image correction value, and stores the generated current correction value information 116 in the storage device 11. The current correction value information 116 is an example of fourth information.

The image corrector 129 corrects the shape of the second projection image GP2 based on the current correction value information 116. The function of the image corrector 129 may be implemented by dedicated hardware instead of the processing device 12.

### 1.4. Specific Operation in Projection Apparatus

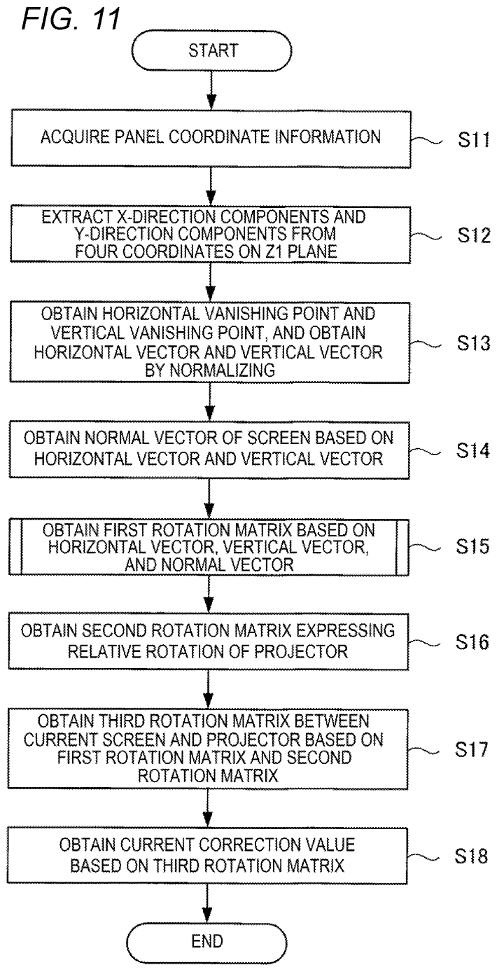

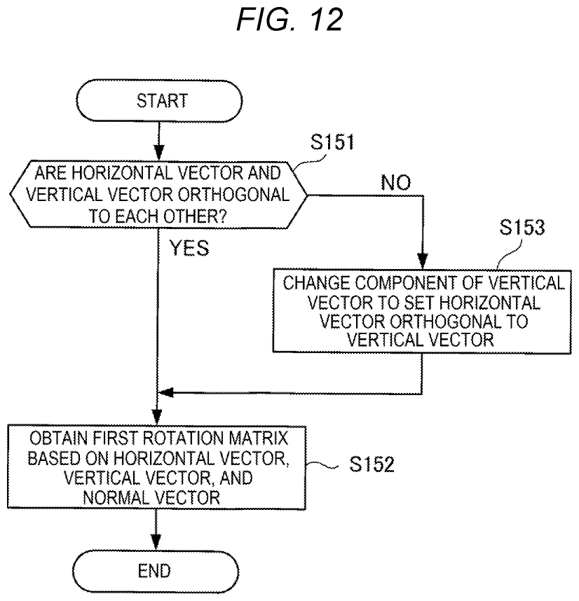

Next, a specific operation in the projection apparatus 10 will be described with reference to FIGS. 11 and 12.

### 1.4.1. Operation of Projection Apparatus (1)

FIG. 11 is a flowchart showing an example of the operation of the processing device 12 shown in FIG. 3. Hereinafter, the operation of the processing device 12 will be described with reference to FIG. 11. The routine in FIG. 11 is started, for example, when the user operates the operation device 14 to call a function of preparing for the installation of the projection apparatus 10 of the projection image.

In step S11, the processing device 12 functions as the acquirer 122 to acquire the panel coordinate information 112 from the storage device 11.

In step S12, the processing device 12 functions as the coordinate transformer 123 to transform the panel coordinates Ap, Bp, Cp, and Dp into the four coordinates A, B, C, and D on the Z1 plane, and extracts the X-direction components and the Y-direction components from the four coordinates A, B, C, and D on the Z1 plane.

In step S13, the processing device 12 functions as the vector calculator 124 to obtain the horizontal vanishing point H∞ and the vertical vanishing point V∞. The horizontal vanishing point H∞ is a point where the extension line L1 of the side AB and the extension line L2 of the side CD of the quadrangle ABCD intersect, and the vertical vanishing point V∞ is a point where the extension line L3 of the side AD and the extension line L4 of the side BC intersect. Furthermore, in step S13, the processing device 12 functions as the vector calculator 124 to obtain the horizontal vector Hc by normalizing the horizontal vanishing point H∞ and the vertical vector Vc by normalizing the vertical vanishing point V∞.

In step S14, the processing device 12 functions as the vector calculator 124 to obtain the normal vector Nc based on the horizontal vector Hc and the vertical vector Vc. Specifically, the normal vector Nc is obtained as an outer product of the horizontal vector Hc and the vertical vector Vc.

In step S15, the processing device 12 functions as the first information generator 125 to obtain the first rotation matrix Rp based on the horizontal vector Hc, the vertical vector Vc, and the normal vector Nc and generate the first matrix information 113. The details of the processing in step S15 will be described later.

In step S16, the processing device 12 functions as the second information generator 126 to obtain the second rotation matrix Rr expressing the relative rotation of the projection apparatus 10 and generate the second matrix information 114.

In step S17, the processing device 12 functions as the third information generator 127 to obtain the third rotation matrix Rn between the screen SC and the current projection apparatus 10 based on the first rotation matrix Rp and the second rotation matrix Rr, and generate the third matrix information 115.

In step S18, the processing device 12 functions as the fourth information generator 128 to obtain the current correction value based on the third rotation matrix Rn, generate the current correction value information 116, and temporarily end the present routine.

### 1.4.2. Operation of Projector (2)

FIG. 12 is a flowchart showing an example of an operation of a subroutine shown in FIG. 11. Hereinafter, the operation of the subroutine of step S15 will be described with reference to FIG. 12.

In step S151, the processing device 12 functions as the orthogonality determiner 1251 to determine whether the horizontal vector Hc and the vertical vector Vc are orthogonal to each other. Specifically, whether the horizontal vector Hc and the vertical vector Vc are orthogonal to each other is determined based on whether the absolute value |cos φ| of the inner product of the horizontal vector Hc and the vertical vector Vc is less than the threshold.

When it is determined that the horizontal vector Hc and the vertical vector Vc are orthogonal to each other, that is, when the determination result in step S151 is YES, the processing device 12 functions as the first information generator 125 in step S152 to obtain the first rotation matrix Rp based on the horizontal vector Hc, the vertical vector Vc, and the normal vector Nc, and temporarily ends the present subroutine.

On the other hand, when it is determined that the horizontal vector Hc and the vertical vector Vc are not orthogonal to each other, that is, when the determination result in step S151 is NO, the processing device 12 functions as the change processor 1252 in step S153 to change the component of the vertical vector Vc such that the horizontal vector Hc and the vertical vector Vc are orthogonal to each other. The component of the vertical vector Vc is changed using, for example, Gram-Schmidt orthogonalization.

In step S152, the processing device 12 functions as the first information generator 125 to obtain the first rotation matrix Rp based on the horizontal vector Hc, the vertical vector Vc, and the normal vector Nc, and temporarily ends the present subroutine.

### 1.5. Effects Achieved by First Embodiment

As described above, the control method for the projection apparatus 10 according to the first embodiment is a control method for the projection apparatus 10 including the light modulator 131 that generates an image and the projection lens 132 that projects the image generated by the light modulator 131 onto the screen SC. The control method includes generating the first matrix information 113 based on the image generated by the light modulator 131 at the first timing, generating the second matrix information 114 indicating the amount of change based on the detection value output from the attitude detection device 16 that detects the amount of change from the attitude of the projection apparatus 10 at the first timing to the attitude thereof at the second timing, generating the third matrix information 115 based on the first matrix information 113 and the second matrix information 114, and generating the current correction value information 116 for correcting the shape of the image at the second timing based on the third matrix information 115. The second timing is at a time after the first timing. The first matrix information 113 is information indicating the relative attitude between the screen SC and the projection lens 132 at the first timing. The third matrix information 115 is information indicating the relative attitude between the screen SC and the projection lens 132 at the second timing.

According to the configuration, even when a sensor that detects the relative amount of change in the attitude is used as the attitude detection device 16, the correction value information for correcting the shape of the image can be generated without performing a method of imaging the screen SC on which a distance detection pattern is projected and performing three-dimensional ranging based on the captured image, a method of performing three-dimensional ranging based on the output of a time of flight (ToF) sensor, or the like. Therefore, the processing for ranging is unnecessary, and the processing load of the processing device 12 is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

Generating the first matrix information 113 includes calculating the horizontal vector Hc indicating the horizontal vanishing point H∞ of the image in the coordinate system having the principal point of the projection lens 132 as the origin and the vertical vector Vc indicating the vertical vanishing point V∞ of the image in the coordinate system based on the image generated by the light modulator 131 at the first timing, calculating the normal vector Nc orthogonal to the horizontal vector Hc and the vertical vector Vc, and calculating the first rotation matrix Rp having the horizontal vector Hc, the vertical vector Vc, and the normal vector Nc as components as the first matrix information 113.

According to the configuration, it is possible to easily calculate the first rotation matrix Rp by using the horizontal vector Hc and the vertical vector Vc respectively corresponding to the horizontal axis and the vertical axis in the coordinate system of the screen SC.

In addition, generating the first matrix information 113 includes determining whether the horizontal vector Hc and the vertical vector Vc are orthogonal to each other, executing the change processing of changing at least one of the component of the horizontal vector Hc and the component of the vertical vector Vc so that the horizontal vector Hc and the vertical vector Vc are orthogonal to each other when it is determined that the horizontal vector Hc and the vertical vector Vc are not orthogonal to each other, and calculating the first rotation matrix Rp based on a result of the change processing.

According to the configuration, it is possible to implement keystone distortion correction with higher accuracy.

The control device according to the first embodiment is a control device for the projection apparatus 10 including the light modulator 131 that generates an image and the projection lens 132 that projects the image generated by the light modulator 131 onto the screen SC. The control device includes the first information generator 125, the second information generator 126, the third information generator 127, and the fourth information generator 128. The first information generator 125 generates the first matrix information 113 indicating the relative attitude between the screen SC and the projection lens 132 at the first timing based on the image generated by the light modulator 131 at the first timing. The second information generator 126 generates the second matrix information 114 indicating the amount of change from the attitude of the projection apparatus 10 at the first timing to the attitude thereof at the second timing based on the detection value output from the attitude detection device 16 that detects the amount of change. The second timing is at a time after the first timing. The third information generator 127 generates the third matrix information 115 indicating the relative attitude between the screen SC and the projection lens 132 at the second timing based on the first matrix information 113 and the second matrix information 114. The fourth information generator 128 generates the current correction value information 116 for correcting the shape of the image at the second timing based on the third matrix information 115.

According to the configuration, even when a sensor that detects the relative amount of change in the attitude is used as the attitude detection device 16, the correction value information for correcting the shape of the image can be generated without performing a method of imaging the screen SC on which a distance detection pattern is projected and performing three-dimensional ranging based on the captured image, a method of performing three-dimensional ranging based on the output of a ToF sensor, or the like. Therefore, the processing for ranging is unnecessary, and the processing load of the processing device 12 is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

The program according to the first embodiment is a program to be executed by a computer that controls the projection apparatus 10 including the light modulator 131 that generates an image and the projection lens 132 that projects the image generated by the light modulator 131 onto the screen SC. The program causes the computer to execute generating the first matrix information 113 indicating the relative attitude between the screen SC and the projection lens 132 at the first timing based on the image generated by the light modulator 131 at the first timing, generating the second matrix information 114 indicating the amount of change from the attitude of the projection apparatus 10 at the first timing to the attitude thereof at the second timing based on the detection value output from the attitude detection device 16 that detects the amount of change, generating the third matrix information 115 indicating the relative attitude between the screen SC and the projection lens 132 at the second timing based on the first matrix information 113 and the second matrix information 114, and generating the current correction value information 116 for correcting the shape of the image at the second timing based on the third matrix information 115. The second timing is at a time after the first timing.

According to the configuration, even when a sensor that detects the relative amount of change in the attitude is used as the attitude detection device 16, the correction value information for correcting the shape of the image can be generated without performing a method of imaging the screen SC on which a distance detection pattern is projected and performing three-dimensional ranging based on the captured image, a method of performing three-dimensional ranging based on the output of a ToF sensor, or the like. Therefore, the processing for ranging is unnecessary, and the processing load of the processing device 12 is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

### 2. Modifications

The present disclosure is not limited to the above embodiment, and various modification examples can be adopted within the scope of the present disclosure. Specific configurations of modifications will be exemplified below. Two or more configurations optionally selected from the following exemplifications can be combined as appropriate to an extent that no contradiction occurs. In the following exemplified modifications, the reference numerals and signs used in the above description are used for elements having actions and functions equivalent to those in the above embodiment, and the detailed description of the elements is omitted as appropriate.

### 2.1. Modification 1

In the first embodiment, when the calculated horizontal vector Hc and vertical vector Vc are not orthogonal to each other, the vertical vector Vc is changed such that the horizontal vector Hc and the vertical vector Vc are orthogonal to each other. This is because, when the projection image has a horizontally long aspect ratio, in a horizontally long quadrangle that is not a perfect rectangle, it is easier for the user to visually recognize that the upper side and the lower side are not parallel to each other than that the left side and the right side are not parallel to each other.

On the other hand, when the projection image has a vertically long aspect ratio, in a vertically long quadrangle that is not a perfect rectangle, it is easier to visually recognize that the left side and the right side are not parallel to each other than that the upper side and the lower side are not parallel to each other. Accordingly, the left side and the right side of the projection image for which the image correction value is determined are less deviated from those of an ideal rectangle than the upper side and the lower side of the projection image. Therefore, when the projection image has a vertically long aspect ratio, the horizontal vector Hc may be adjusted without adjusting the vertical vector Vc.

The change processing changes the component of the vertical vector Vc without changing the component of the horizontal vector Hc when the shape of the image is horizontally long, and changes the component of the horizontal vector Hc without changing the component of the vertical vector Vc when the shape of the image is vertically long.

When the projection image is not completely rectangular on the screen SC, it is easier to visually recognize that the long sides of the projection images are not parallel to each other than that the short sides of the projection images are not parallel to each other. Accordingly, it is assumed that the degree of parallelism between the long sides of the projection image after the keystone distortion correction is higher than the degree of parallelism between the short sides. Therefore, according to the configuration, since only the component of the vector corresponding to the short side of the projection image of the horizontal vector Hc and the vertical vector Vc is changed, it is possible to make the projection image closer to a rectangle more easily.

That is, the change processing may be processing of changing one of the component of the horizontal vector Hc and the component of the vertical vector Vc based on the aspect information indicating the aspect ratio of the generated image IM1. The aspect information is an example of fifth information. The aspect information is not limited to the information indicating the aspect ratio of the generated image IM1, and may be information indicating the aspect ratio of the input image input to the projector 13. The processing device 12 may acquire the aspect information at least at any timing before step S153 in FIG. 12, and the acquisition timing is not particularly limited. When the aspect ratio is 1, the processing device 12 may perform processing of changing any one component of the component of the horizontal vector Hc and the component of the vertical vector Vc.

### 2.2. Modification 2

In the first embodiment, the first information generator 125 has the functions of the orthogonality determiner 1251 and the change processor 1252, but the vector calculator 124 may have the functions of the orthogonality determiner and the change processor.

### 2.3. Modification 3

In the first embodiment, a gyro sensor, a rotary encoder, or the like capable of detecting the relative amount of change in the attitude is applied to the attitude detection device 16, but a sensor capable of detecting the absolute amount of change in the attitude may be applied to the attitude detection device 16. Examples of the sensor capable of detecting the absolute amount of change in the attitude include a ToF sensor, an acceleration sensor, and an inertial measurement unit (IMU). In any case, it is possible to implement the distortion correction of the projection image by combining the screen SC serving as the reference, the image correction value adjusted such that the projection image is rectangular on the screen SC, and the sensor capable of acquiring at least the relative rotation amount of the projection apparatus 10 with reference to the correction time point at which the image correction value is determined.

### 2.4. Modification 4

In the first embodiment, the third rotation matrix Rn is obtained based on the first rotation matrix Rp and the second rotation matrix Rr, but it is also possible to obtain the normal vector and the gravity vector in the projector coordinate system based on the first rotation matrix Rp and the second rotation matrix Rr, and then replace a part of the correction value with a value of a sensor capable of acquiring an absolute value. The sensor capable of acquiring an absolute value is a ToF sensor, an acceleration sensor, or the like. In addition, an output value from a ToF sensor, an acceleration sensor, or the like and an output value from a gyro sensor may be used in combination.

### 3. Appendices

The present disclosure will be summarized below as appendices.

### 3.1. Appendix 1

A control method for a projection apparatus according to Appendix 1 is a control method for a projection apparatus including an image generation element that generates an image and a projection lens that projects the image generated by the image generation element onto a projection target, and the control method includes generating first information indicating a relative attitude between the projection target and the projection lens at a first timing based on the image generated by the image generation element at the first timing, generating second information indicating an amount of change from an attitude of the projection apparatus at the first timing to an attitude at a second timing at a time after the first timing based on a detection value output from a sensor that detects the amount of change, generating third information indicating a relative attitude between the projection target and the projection lens at the second timing based on the first information and the second information, and generating fourth information for correcting a shape of the image at the second timing based on the third information.

According to the control method for a projection apparatus according to Appendix 1, even when a sensor that detects the relative amount of change in the attitude is used as the attitude detection device, the correction value information for correcting the shape of the image can be generated without performing a method of imaging the screen on which a distance detection pattern is projected and performing three-dimensional ranging based on the captured image, a method of performing three-dimensional ranging based on the output of a ToF sensor, or the like. Therefore, processing for ranging is unnecessary, and the processing load of the processing device is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

### 3.2. Appendix 2

In the control method for a projection apparatus according to Appendix 2, in Appendix 1, generating the first information includes calculating a first vector indicating a horizontal vanishing point of the image in a coordinate system having an origin at a principal point of the projection lens and a second vector indicating a vertical vanishing point of the image in the coordinate system based on the image generated by the image generation element at the first timing, calculating a third vector orthogonal to the first vector and the second vector, and calculating a matrix having the first vector, the second vector, and the third vector as components as the first information.

According to the control method for a projection apparatus according to Appendix 2, it is possible to easily calculate the matrix by using the first vector and the second vector respectively corresponding to the horizontal axis and the vertical axis in the coordinate system of the screen.

### 3.3. Appendix 3

In the control method for a projection apparatus according to Appendix 3, in Appendix 2, generating the first information includes determining whether the first vector and the second vector are orthogonal to each other, executing change processing of changing at least one of a component of the first vector and a component of the second vector to set the first vector orthogonal to the second vector when determining that the first vector and the second vector are not orthogonal to each other, and calculating the matrix based on a result of the change processing.

According to the control method for a projection apparatus according to Appendix 3, it is possible to implement keystone distortion correction with higher accuracy.

### 3.4. Appendix 4

In the control method for a projection apparatus according to Appendix 4, in Appendix 3, the change processing is processing of changing one of the component of the first vector and the component of the second vector based on fifth information indicating an aspect ratio of the image or an input image input to the projection apparatus.

When the projection image is not completely rectangular on the screen, it is easier to visually recognize that the long sides of the projection images are not parallel to each other than that the short sides of the projection images are not parallel to each other. Accordingly, it is assumed that the degree of parallelism between the long sides of the projection image after the keystone distortion correction is higher than the degree of parallelism between the short sides. Therefore, according to the control method for a projection apparatus according to Appendix 4, since only the component of the vector corresponding to the short side of the projection image of the first vector and the second vector is changed, it is possible to make the projection image closer to a rectangle more easily.

### 3.5. Appendix 5

A control device for a projection apparatus according to Appendix 5 is a control device for a projection apparatus including an image generation element that generates an image and a projection lens that projects the image generated by the image generation element onto a projection target, and the control device includes a first information generator that generates first information indicating a relative attitude between the projection target and the projection lens at a first timing based on the image generated by the image generation element at the first timing, a second information generator that generates second information indicating an amount of change from an attitude of the projection apparatus at the first timing to an attitude at a second timing at a time after the first timing based on a detection value output from a sensor that detects the amount of change, a third information generator that generates third information indicating a relative attitude between the projection target and the projection lens at the second timing based on the first information and the second information, and a fourth information generator that generates fourth information for correcting a shape of the image at the second timing based on the third information.

According to the control device for the projection apparatus according to Appendix 5, even when a sensor that detects the relative amount of change in the attitude is used as the attitude detection device, the correction value information for correcting the shape of the image can be generated without performing a method of imaging the screen on which a distance detection pattern is projected and performing three-dimensional ranging based on the captured image, a method of performing three-dimensional ranging based on the output of a ToF sensor, or the like. Therefore, processing for ranging is unnecessary, and the processing load of the processing device is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

### 3.6. Appendix 6

A non-transitory computer-readable storage medium storing a program according to Appendix 6 causes a computer that controls a projection apparatus including an image generation element that generates an image and a projection lens that projects the image generated by the image generation element onto a projection target to execute generating first information indicating a relative attitude between the projection target and the projection lens at a first timing based on the image generated by the image generation element at the first timing, generating second information indicating an amount of change from an attitude of the projection apparatus at the first timing to an attitude at a second timing at a time after the first timing based on a detection value output from a sensor that detects the amount of change, generating third information indicating a relative attitude between the projection target and the projection lens at the second timing based on the first information and the second information, and generating fourth information for correcting a shape of the image at the second timing based on the third information.

According to the non-transitory computer-readable storage medium storing a program according to Appendix 6, even when a sensor that detects the relative amount of change in the attitude is used as the attitude detection device, the correction value information for correcting the shape of the image can be generated without performing a method of imaging the screen on which a distance detection pattern is projected and performing three-dimensional ranging based on the captured image, a method of performing three-dimensional ranging based on the output of a ToF sensor, or the like. Therefore, processing for ranging is unnecessary, and the processing load of the processing device is reduced. Furthermore, a device for ranging and a time for ranging are unnecessary. In addition, according to the configuration, since the attitude information obtained from the three-dimensional ranging is unnecessary, even when the shape of the projection image is corrected by the user at the time of the previous correction not by the three-dimensional ranging, the correction value information can be easily generated.

What is claimed is:

1. A control method for a projection apparatus including an image generation element that generates an image and a projection lens that projects the image generated by the image generation element onto a projection target, the control method comprising:
generating first information indicating a relative attitude between the projection target and the projection lens at a first timing based on the image generated by the image generation element at the first timing;
generating second information indicating an amount of change from an attitude of the projection apparatus at the first timing to an attitude at a second timing at a time after the first timing based on a detection value output from a sensor that detects the amount of change;
generating third information indicating a relative attitude between the projection target and the projection lens at the second timing based on the first information and the second information; and
generating fourth information for correcting a shape of the image at the second timing based on the third information.

2. The control method according to claim 1, wherein
generating the first information includes:
calculating a first vector indicating a horizontal vanishing point of the image in a coordinate system having an origin at a principal point of the projection lens and a second vector indicating a vertical vanishing point of the image in the coordinate system based on the image generated by the image generation element at the first timing;
calculating a third vector orthogonal to the first vector and the second vector; and
calculating a matrix having the first vector, the second vector, and the third vector as components as the first information.

3. The control method according to claim 2, wherein
generating the first information includes:
determining whether the first vector and the second vector are orthogonal to each other;
executing change processing of changing at least one of a component of the first vector and a component of the second vector to set the first vector orthogonal to the second vector when determining that the first vector and the second vector are not orthogonal to each other; and
calculating the matrix based on a result of the change processing.

4. The control method according to claim 3, wherein
the change processing is processing of changing one of the component of the first vector and the component of the second vector based on fifth information indicating an aspect ratio of the image or an input image input to the projection apparatus.

5. A control device for a projection apparatus including an image generation element that generates an image and a projection lens that projects the image generated by the image generation element onto a projection target, the control device comprising:
a first information generator that generates first information indicating a relative attitude between the projection target and the projection lens at a first timing based on the image generated by the image generation element at the first timing;
a second information generator that generates second information indicating an amount of change from an attitude of the projection apparatus at the first timing to an attitude at a second timing at a time after the first timing based on a detection value output from a sensor that detects the amount of change;
a third information generator that generates third information indicating a relative attitude between the projection target and the projection lens at the second timing based on the first information and the second information; and
a fourth information generator that generates fourth information for correcting a shape of the image at the second timing based on the third information.

6. A non-transitory computer-readable storage medium storing a program causing a computer that controls a projection apparatus including an image generation element that generates an image and a projection lens that projects the image generated by the image generation element onto a projection target to execute:
generating first information indicating a relative attitude between the projection target and the projection lens at a first timing based on the image generated by the image generation element at the first timing;
generating second information indicating an amount of change from an attitude of the projection apparatus at the first timing to an attitude at a second timing at a time after the first timing based on a detection value output from a sensor that detects the amount of change;
generating third information indicating a relative attitude between the projection target and the projection lens at the second timing based on the first information and the second information; and
generating fourth information for correcting a shape of the image at the second timing based on the third information.
